(19) United States
(12) Patent Application Publication
(10) Pub. No.: US 2023/0236778 A1
(43) Pub. Date: Jul. 27, 2023

(54) PROCESSING APPARATUS, METHOD, AND NON-TRANSITORY COMPUTER READABLE MEDIUM

(71) Applicant: FUJIFILM BUSINESS INNOVATION CORP., Tokyo (JP)

(72) Inventor: Yutaro SUGIBAYASHI, Kanagawa (JP)

(73) Assignee: FUJIFILM BUSINESS INNOVATION CORP., Tokyo (JP)

(21) Appl. No.: 17/869,921

(22) Filed: Jul. 21, 2022

(30) Foreign Application Priority Data
Jan. 24, 2022 (JP) 2022-008989

(51) Int. Cl. G06F 3/12

(52) U.S. Cl. CPC G06F 3/1226; G06F 3/1285; G06F 3/121; G06F 3/1205

(57) ABSTRACT

A processing apparatus includes a processor configured to: reference host device information that represents device attributes provided to a host device and different device information that represents device attributes provided to a different device; and notify a user that uses the host device of device attributes of the host device that are not provided to the different device as characteristic information on the host device.

### CROSS-REFERENCE TO RELATED APPLICATIONS

This application is based on and claims priority under 35 USC 119 from Japanese Patent Application No. 2022-008989 filed Jan. 24, 2022.

### BACKGROUND

### (i) Technical Field

The present disclosure relates to a processing apparatus, a method, and a non-transitory computer readable medium.

### (ii) Related Art

Japanese Patent No. 4881205 discloses a bookmark management device that manages a bookmark, including: a uniform resource locator (URL) reception unit that receives identification information for identifying a user and a target URL, which is the URL of a target web page which is a web page that the user desires to bookmark, from a terminal device capable of communicating with the bookmark management device; an address information extraction unit that accesses the target web page using the URL and extracts a telephone number as address information on the basis of a combination of numerals and symbols from the target web page; a position conversion unit that converts the address information into registered coordinate information that includes a latitude and a longitude; a bookmark registration unit that registers the target URL and the registered coordinate information in association with each other as a bookmark; a coordinate information reception unit that receives calling coordinate information from the terminal device when the bookmark is called by the terminal device; a bookmark transmission unit that transmits information that indicates the bookmark to the terminal device using the shortness of the distance between a coordinate indicated by the calling coordinate information and a coordinate indicated by the registered coordinate information as a priority condition; an advertisement information storage unit that stores advertisement information in association with a designated transmission range; a deviation determination unit that determines the deviation in the coordinate indicated by the registered coordinate information for each user; and an advertisement information transmission unit that transmits the advertisement information with the designated transmission range including a coordinate determined by the deviation determination unit to the terminal device of each user.

Japanese Patent No. 6410504 discloses an information processing device that includes a browser function, including: a first storage unit that stores access limitation information for a function in association with a user; a registration unit that registers a web application, a URL of a connection destination of the web application, and function classification information as a bookmark with a screen of the web application displayed through the browser function; a holding unit that holds the URL of the connection destination registered by the registration unit and function classification information that represents the function of the connection destination as bookmark information; a second storage unit that stores a button to be displayed on a menu screen, function classification information associated with the button, and information indicating a bookmark attribute in the function classification information in the case where the button has a bookmark attribute, as button information; a determination unit that determines whether the function classification information associated with the button information held by the holding unit corresponds to the function subjected to the limitation by the access limitation information stored in the first storage unit corresponding to a user that has logged in in the case where the button information on the button included in the menu screen has the bookmark attribute when displaying the menu screen; and a control unit that performs control so as to display the menu screen with the button having the bookmark attribute rendered inoperable when it is determined by the determination unit that the function classification information corresponds to the function subjected to the limitation by the access limitation information corresponding to the user that has logged in.

Japanese Patent No. 5142519 discloses a data processing device for installation of a resource for using a device, including: an input unit that allows input of location information that indicates the location of a device; a first acquisition unit that acquires device information for specifying a device located at a location corresponding to the location information input using the input unit; an installation unit that allows downloading and installation of a resource for using the device indicated by the device information acquired by the first acquisition unit; a first display unit that displays, among devices corresponding to the resource installed in the data processing device, a device for which a resource has been installed and which is located at a location different from the location corresponding to the location information input using the input unit; and an uninstallation unit that, when instructed to uninstall the resource corresponding to the device displayed on the first display unit, uninstalls the resource, the uninstallation unit not uninstalling the resource when not instructed to uninstall the resource corresponding to the device displayed on the first display unit.

Japanese Patent No. 5578523 discloses an information processing device that includes a storage section that stores device information that includes connection information for a plurality of peripheral devices and a display section and that is connected to an external information processing device different from the peripheral devices via a network, in which: the types of the peripheral devices include a printer and a scanner that need a device driver in order for the peripheral devices to be used; the information processing device includes a display control unit that controls display on the display section of a user interface including icons in different shapes corresponding to the types of the plurality of peripheral devices using device information on the plurality of peripheral devices stored in the storage section, an installation control unit that controls execution of an installation process of installing the device driver in the information processing device, and an uninstallation control unit that controls execution of an uninstallation process of uninstalling the device driver; the plurality of peripheral devices to be displayed as icons on the user interface include a peripheral device with a corresponding device driver installed in the information processing device, and a peripheral device with a corresponding device driver not installed in the information processing device; in the case where a user performs an operation to display a menu related to a peripheral device on the user interface after a peripheral device is selected via the user interface, the display control unit performs control so as to additionally display on the user interface a menu for designating installation or uninstallation of a device driver for the selected peripheral device; when an instruction for installation is given via the additionally displayed menu after a peripheral device, a device driver for which is not installed in the information processing device, is selected via the user interface, setting information corresponding to the device driver for the selected peripheral device is acquired by the information processing device from the external information processing device, and the installation control unit controls execution of an installation process of installing the device driver in the information processing device using the setting information; and when an instruction for uninstallation is given via the additionally displayed menu after a peripheral device, a device driver for which has been installed in the information processing device, is selected via the user interface, the uninstallation control unit controls execution of an uninstallation process of uninstalling the device driver for the selected peripheral device.

### SUMMARY

A plurality of processing apparatuses that perform processes determined in advance such as printers, for example, are occasionally installed in a building.

In the case where a user attempts to print a document using a printer in such a situation, the user uses any of the printers. However, the installed printers may be of different models, depending on the difference in the time when the printers were introduced etc., and may have different configurations or settings.

Thus, when there are a large number of printers, it is difficult for the user to grasp in advance characteristic configurations and settings of the printers, such as whether the printer that the user is attempting to use supports color printing, for example.

Aspects of non-limiting embodiments of the present disclosure relate to providing a processing apparatus, a method, and a non-transitory computer readable medium capable of notifying a user of a characteristic of a function of a processing apparatus in the case where the user executes the function of the processing apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a processing apparatus including a processor configured to: reference host device information that represents device attributes provided to a host device and different device information that represents device attributes provided to a different device; and notify a user that uses the host device of device attributes of the host device that are not provided to the different device as characteristic information on the host device.

### BRIEF DESCRIPTION OF THE DRAWINGS

An exemplary embodiment of the present disclosure will be described in detail based on the following figures, wherein:

FIG. 1 illustrates an example of a processing system;

FIG. 2 illustrates an example of the functional configuration of an image forming device;

FIG. 3 illustrates an example of a host device attribute list;

FIG. 4 illustrates an example of a device list;

FIG. 5 illustrates an example of the configuration of an electrical system of the image forming device;

FIG. 6 is a flowchart illustrating an example of the flow of a device attribute collection process;

FIG. 7 is a flowchart illustrating an example of the flow of a list generation process;

FIG. 8 illustrates an example of a characteristic data list;

FIG. 9 illustrates an example of a similar data list;

FIG. 10 illustrates an example of a similarity degree list;

FIG. 11 is a flowchart illustrating an example of the flow of an operation screen display process;

FIG. 12 illustrates an example of a home screen to be displayed on a user terminal;

FIG. 13 illustrates an example of a copy screen to be displayed on the user terminal;

FIG. 14 illustrates an example of a print screen to be displayed on the user terminal;

FIG. 15 illustrates an example of a home screen with a mimic image to be displayed on the user terminal;

FIG. 16 illustrates an example of a copy screen with a mimic image to be displayed on the user terminal;

FIG. 17 illustrates an example of a print screen with a mimic image to be displayed on the user terminal;

FIG. 18 illustrates an example of a home screen to be displayed on the image forming device;

FIG. 19 is a flowchart illustrating an example of the flow of a substitute process;

FIG. 20 illustrates an example of a home screen that includes information about a substitute device to be displayed on the user terminal;

FIG. 21 illustrates an example of a home screen that includes information about a substitute device to be displayed on the image forming device;

FIG. 22 illustrates an example of a print screen that includes information about a substitute device to be displayed on the user terminal;

FIG. 23 illustrates an example of a print screen that includes information related to a substitute device to be displayed on the image forming apparatus;

FIG. 24 illustrates an example of a setting screen;

FIG. 25 illustrates an example of a dialog; and

FIG. 26 illustrates an example of a select screen.

### DETAILED DESCRIPTION

The present exemplary embodiment will be described below with reference to the drawings. Like constituent elements and like processes are denoted by like reference numerals throughout the drawings to omit redundant description.

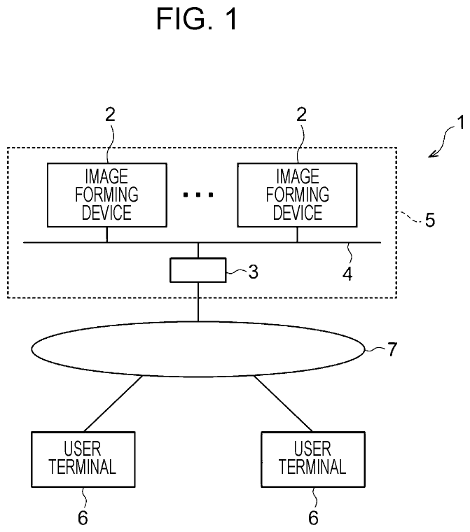

FIG. 1 illustrates an example of a processing system 1 according to the present exemplary embodiment. The processing system 1 includes a plurality of image forming devices 2, a firewall 3, and at least one user terminal 6.

The image forming devices 2 and the firewall 3 are installed in a building 5 of a company for which a user works, for example. The image forming devices 2 and the firewall 3 are connected to each other through an intranet 4 that is connectable from only specific authorized users, such as users that work in the company, for example. The user terminals 6 are connected to a wide area network (WAN) 7 constructed by the Internet etc., for example, and connected to each of the image forming devices 2 in the company through the firewall 3 also connected to the WAN 7. The intranet 4 is a communication line in the building 5, and the WAN 7 is a communication line outside the building 5. Thus, the intranet 4 is an example of an internal communication line, and the WAN 7 is an example of an external communication line.

The image forming device 2 is a device that includes a plurality of functions related to images. Specifically, the image forming device 2 includes a print function to form an image represented by data on a recording medium such as paper, a copy function to form an image that is the same as an image formed on a recording medium on a different recording medium, and a facsimile (also referred to as “FAX”) function to transmit and receive data through a facsimile line (not illustrated). The functions of the image forming device 2 are not limited to the print function, the copy function, and the facsimile function, and the image forming device 2 may include any function. For example, the image forming device 2 may include a scan function to read an image formed on a recording medium as image data.

The image forming devices 2 according to the present exemplary embodiment are an example of the processing apparatuses in the processing system 1. While the processing apparatuses in the processing system 1 will be described below using the image forming devices 2 as an example, the processing apparatuses may be apparatuses of any type as long as a plurality of processing apparatuses are connected to the intranet 4, transmit and receive data therebetween, and control operation of the apparatuses themselves using the received data. That is, the processing apparatuses are not limited to the image forming devices 2. Thus, the content according to the present exemplary embodiment is also applicable to other processing apparatuses such as ticket vending devices, for example.

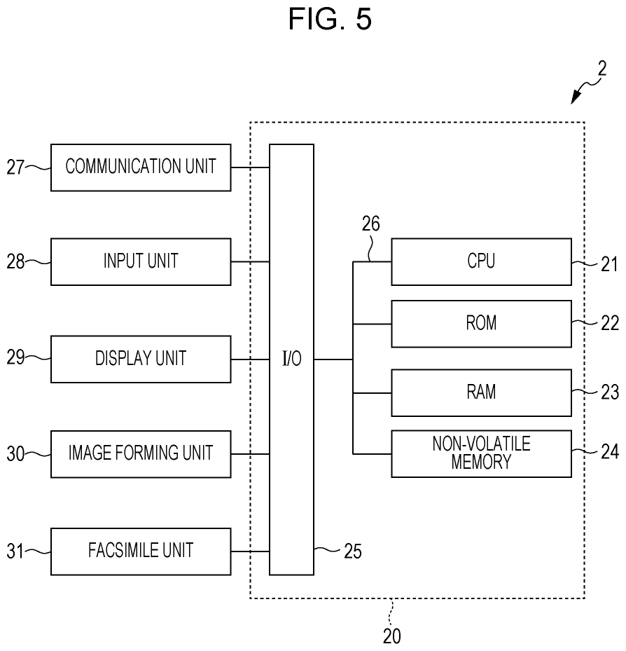

The image forming device 2 may be operated by touching an input unit 28 (see FIG. 5), to be discussed later, provided on the image forming device 2 or through an operation screen displayed on the user terminal 6 from the outside of the building 5, for example. As a matter of course, the user may operate the image forming device 2 through the operation screen displayed on the user terminal 6, even if the user is in the building 5. In this case, the user connects the user terminal 6 to the intranet 4.

For convenience of description, the image forming device 2 itself is occasionally referred to as a “host device 2”, and the other image forming devices 2 included in the processing system 1 are occasionally referred to as “different devices 2”. The different devices 2 according to the present exemplary embodiment are an example of “different devices”.

The user terminal 6 is an information device that is used by the user that uses the image forming device 2, and includes a communication function to connect to the WAN 7, and a user interface (UI) that displays information from the image forming device 2 and that receives an instruction (referred to as an “operation”) on the image forming device 2 from the user. Specifically, the user terminal 6 may be a computer, a smartphone, a tablet terminal, and a wearable terminal, etc., for example.

The user performs an operation using the user terminal 6 through an operation screen (referred to as a “remote operation screen 35A”) displayed in a browser of the user terminal 6 by designating an IP address uniquely allocated to each of the image forming devices 2 from the browser. That is, while the image forming device 2 includes a web UI that receives an operation by the user through a communication line, the web UI is not necessary for the image forming device 2, and the image forming device 2 may receive at least one of an operation from the input unit 28 and an operation from the remote operation screen 35A.

An operation screen displayed on a display unit 29 (see FIG. 5) of the image forming device 2, to be discussed later, is referred to as a “local operation screen 35B”, in contrast to the remote operation screen 35A. The remote operation screen 35A and the local operation screen 35B will be described later. In the following, the remote operation screen 35A and the local operation screen 35B will be referred to as an “operation screen 35” in the case where it is not necessary to distinguish the remote operation screen 35A and the local operation screen 35B from each other.

While only the image forming devices 2 and the firewall 3 are connected to the intranet 4 for convenience of illustration in FIG. 1, information devices such as computers, for example, are also connected to the intranet 4 in reality.

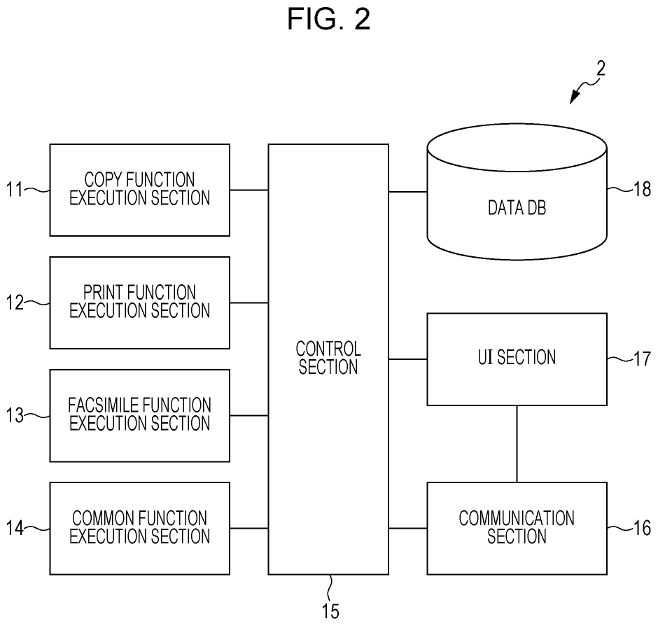

FIG. 2 illustrates an example of the functional configuration of the image forming device 2. The image forming device 2 includes various functional sections such as a copy function execution section 11, a print function execution section 12, a facsimile function execution section 13, a common function execution section 14, a communication section 16, and a UI section 17, and a data database (DB) 18. “DB” is an abbreviation of “database”, and is a collection of data needed for the image forming device 2 to operate and stored in a storage device.

The copy function execution section 11 executes a process related to a copy function on the basis of an instruction from a control section 15.

The print function execution section 12 executes a process related to a print function on the basis of an instruction from the control section 15.

The facsimile function execution section 13 executes a process related to a facsimile function on the basis of an instruction from the control section 15.

The common function execution section 14 executes a process related to a function (referred to as a “common function”) that is commonly used for the copy function, the print function, and the facsimile function on the basis of an instruction from the control section 15. The common function includes a function related to power saving of the image forming device 2, a function related to recording of an operation history, etc., for example.

While the image forming devices 2 included in the processing system 1 include the copy function execution section 11, the print function execution section 12, and the common function execution section 14, by way of example, whether or not the image forming devices 2 include the facsimile function execution section 13 is different among the image forming devices 2. That is, while the image forming devices 2 include the common function, the copy function, and the print function, whether the image forming devices 12 include the facsimile function is different in accordance with the type of the image forming devices 2. Thus, the common function, the copy function, and the print function are called standard functions of the image forming devices 2, and the facsimile function is called an optional function of the image forming devices 2.

The communication section 16 performs data communication with a different device 2 through the intranet 4, and performs data communication with the user terminal 6 connected to the WAN 7 by way of the firewall 3 connected to the intranet 4, on the basis of an instruction from the control section 15. In the case where data are received from the user terminal 6, the communication section 16 notifies the UI section 17, since the received data represent the content of an operation on the remote operation screen 35A.

The UI section 17 receives an operation by the user performed through the operation screen 35, and notifies the control section 15.

In the case where an operation by the user is received through the remote operation screen 35A, the UI section 17 causes a browser of the user terminal 6 to display a new screen by generating a new screen (image data in reality) corresponding to the operation by the user, and transmitting the generated new screen to the user terminal 6 by way of the communication section 16, on the basis of an instruction from the control section 15. In the case where an operation by the user is received through the local operation screen 35B, meanwhile, the UI section 17 generates a new screen corresponding to the operation by the user, and displays the generated new screen on the input unit 28, on the basis of an instruction from the control section 15.

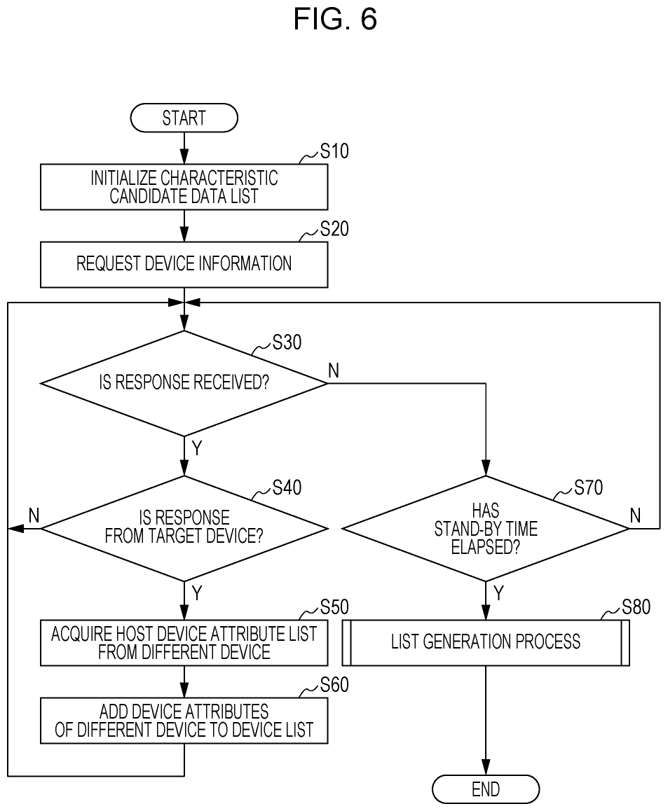

The data DB 18 stores in advance a host device attribute list 8 that centrally stores information about device attributes of the host device 2. The data DB 18 also stores a device list 9 generated through a device attribute collection process to be described later with reference to FIG. 6, a characteristic data list 32, a similar data list 33, and a similarity degree list 34.

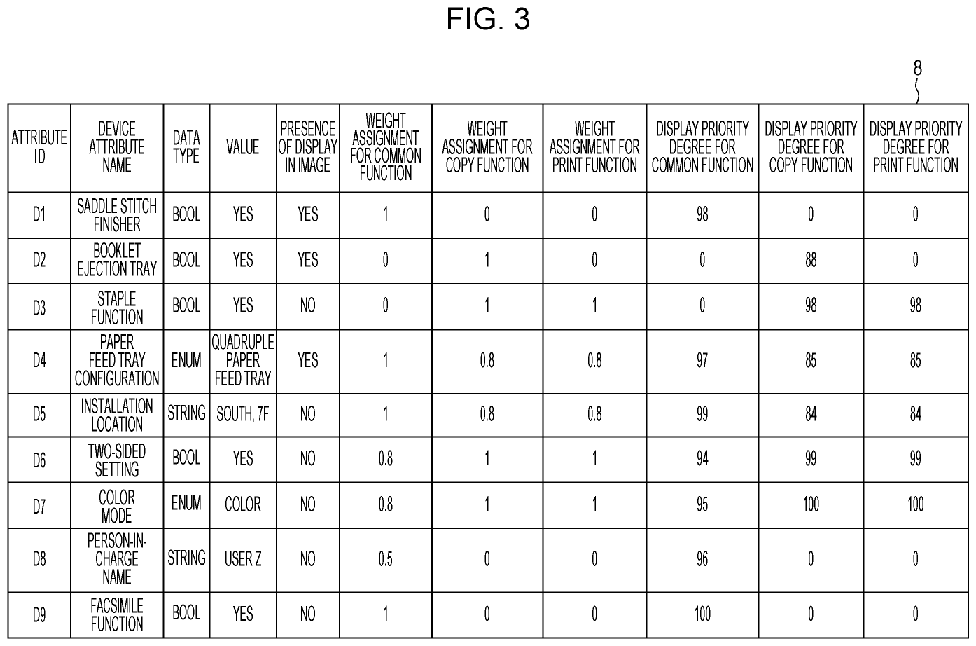

FIG. 3 illustrates an example of the host device attribute list 8. As illustrated in FIG. 3, the host device attribute list 8 is a list set in advance of information about each of the device attributes of the host device 2. The device attributes are the content of each of the physical device configuration, function, setting items, and management contents of the image forming device 2, or in other words information that represents the specifications of the image forming device 2.

Among the device attributes in the host device attribute list 8 illustrated in FIG. 3, the saddle stitch finisher, the booklet ejection tray, and the paper feed tray configuration represent device configurations of the image forming device 2, and the staple function and the facsimile function represent functions of the image forming device 2. The two-sided setting and the color mode represent setting items of the image forming device 2, and the installation location and the person-in-charge name represent management contents of the image forming device 2.

The saddle stitch finisher is a device that binds ejected recording media at the middle with a staple. The booklet ejection tray is a device that folds ejected recording media, processes the recording media into a booklet, and ejects the booklet. The paper feed tray configuration is the configuration of a tray that accommodates unused recording media. The “tray” according to the present exemplary embodiment refers to a box or a shelf that accommodates a stack of recording media to be used by the image forming device 2.

The staple function is a function to put a staple into ejected recording media to bind the recording media. The two-sided setting is a setting item to form an image on both surfaces of a recording medium. The color mode is a setting item to form a color image on a recording medium using color materials for cyan, magenta, yellow, and black, for example.

The installation location represents the location of installation of the image forming device 2 in the building 5. The person-in-charge name represents identification information (e.g. name or user identification (ID)) for identifying the user that manages the image forming device 2.

A unique attribute ID is allocated to each of the device attributes. Information such as the data type, the value, the presence of display in image, the weight assignment for common function, the weight assignment for copy function, the weight assignment for print function, the display priority degree for common function, the display priority degree for copy function, and the display priority degree for print function, for example, is correlated with the device attributes.

Information about the device attributes prescribed in the host device attribute list 8 will be described using the device attribute “saddle stitch finisher”, to which an attribute ID of “Dl” is allocated, as an example.

The name of the device attribute is set using a character string in the “device attribute name” column in the host device attribute list 8. An object represented by the device attribute name is the device attribute itself, and thus the device attribute name represents the device attribute of the host device 2.

The “data type” column in the host device attribute list 8 represents the data type of a value to be described next. “Bool” indicates that the value is a choice of two alternatives, namely “Yes” and “No”. “Enum” indicates that the value is selected from a plurality of items, the number of which being determined in advance. “String” indicates that the value is represented by a character sting freely set by the user.

For the saddle stitch finisher, it is necessary to represent whether or not the host device 2 includes a saddle stitch finisher, and therefore the data type is set to “Bool”.

A value that represents the content or the status of the corresponding device attribute is set in the “value” column in the host device attribute list 8. For the saddle stitch finisher, a value “Yes” is set if the host device 2 includes a saddle stitch finisher, and a value “No” is set if the host device 2 does not include a saddle stitch finisher.

The “presence of display in image” column in the host device attribute list 8 represents whether or not a position in the host device 2 associated with the device attribute set as characteristic information is displayed on the operation screen 35 using an image. If the value is set to “Yes”, the position in the host device 2 associated with the device attribute is displayed on the operation screen 35 using an image. If the value is set to “No”, the position in the host device 2 associated with the device attribute is not displayed on the operation screen 35. The “characteristic information” refers to a device attribute that is characteristic of the host device 2 compared to the different device 2.

That is, the characteristic information refers to information to be referenced when the user selects an image forming device 2 capable of executing a process desired by the user, from among the plurality of image forming devices 2.

A method of setting the characteristic information on the host device 2 will be described in detail later.

The “weight assignment for common function” column in the host device attribute list 8 represents the weight, that is, the degree of contribution, that prescribes how much the coincidence/non-coincidence between the values of the corresponding device attribute affects calculation of the degree of similarity about the common function when the degree of similarity between the device attribute of the host device 2 and the device attribute of the different device 2 is calculated for each function. The weight is represented by a value of 0 or more and 1 or less, for example, and a larger weight value means that the corresponding device attribute affects the calculation of the degree of similarity more significantly.

Thus, it is meant that a device attribute with the weight assignment for common function set to “0” does not affect calculation of the degree of similarity about the common function with the different device 2.

Similarly, the “weight assignment for copy function” column in the host device attribute list 8 represents the degree of contribution of the corresponding device attribute to calculation of the degree of similarity when the degree of similarity about the copy function between the host device 2 and the different device 2 is calculated. In addition, the “weight assignment for print function” column in the host device attribute list 8 represents the degree of contribution of the corresponding device attribute to calculation of the degree of similarity when the degree of similarity about the print function between the host device 2 and the different device 2 is calculated.

In this manner, in the host device attribute list 8, the weight of each device attribute for calculating the degree of similarity between the host device 2 and the different device 2 is set for each function provided in common to the image forming devices 2, that is, each standard function.

On the other hand, the “display priority degree for common function” column in the host device attribute list 8 indicates information that prescribes what order a plurality of device attributes may be displayed in in the case where device attributes related to the common function are to be displayed on the operation screen 35.

The degree of priority for display is represented by a value of 0 or more and 100 or less, for example, and it is meant that the device attributes are displayed on the operation screen 35 in the descending order of the value of the degree of priority for display.

Similarly, the “display priority degree for copy function” column in the host device attribute list 8 indicates information that prescribes what order a plurality of device attributes may be displayed in in the case where device attributes related to the copy function are to be displayed on the operation screen 35. In addition, the “display priority degree for print function” column in the host device attribute list 8 indicates information that prescribes what order a plurality of device attributes may be displayed in in the case where device attributes related to the print function are to be displayed on the operation screen 35.

In the host device attribute list 8, in this manner, the degree of priority for display of a device attribute to be displayed on the operation screen 35 is set for each standard function of the image forming device 2.

The range of values that may be taken by the weight and the degree of priority for display and the meaning of the values discussed above are exemplary. Thus, the weight may be represented by a value of 0 or more and 10 or less, for example, and a larger weight value may mean that the corresponding device attribute affects the calculation of the degree of similarity less significantly. Alternatively, the degree of priority for display may be represented by a value of −1 or more and 0 or less, for example, and it may be meant that the device attributes are displayed on the operation screen 35 in the ascending order of the value of the degree of priority for display.

The content of the host device attribute list 8 is set in advance by a person in charge that manages the image forming devices 2. The information included in the host device attribute list 8 is an example of host device information that represents the device attributes of the host device 2.

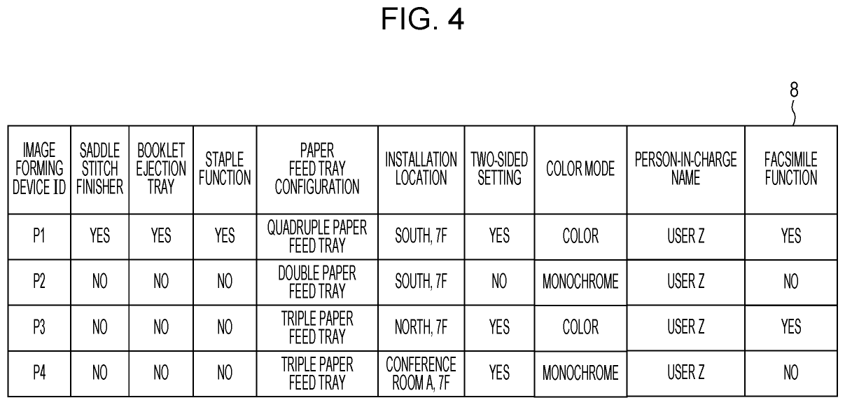

FIG. 4 illustrates an example of the device list 9 stored in the data DB 18. Unlike the host device attribute list 8, the device list 9 is not a list stored in advance in the data DB 18, but is a list generated through the device attribute collection process to be discussed later.

The device list 9 is a list generated by collecting values of the device attributes in the host device attribute list 8 stored in each of the image forming devices 2 from each of the image forming devices 2 included in the processing system 1. Information included in the device list 9 is an example of different device information that represents the device attributes of the different devices 2. While the device list 9 illustrated in FIG. 4 includes the values of the device attributes of the host device 2 (values included in a row with an image forming device ID of “P1”), it is not necessary that the values of the device attributes of the host device 2 should be included in the device list 9, since the values of the device attributes of the host device 2 are stored in the host device attribute list 8.

The device list 9 is a list generated by each of the image forming devices 2. As illustrated in FIG. 4, the device list 9 includes the values of the device attributes in the host device attribute list 8 for each of the image forming devices 2 included in the processing system 1. An image forming device ID is set to each of the image forming devices 2 included in the processing system 1, in order to manage the image forming devices 2. In the example illustrated in FIG. 4, there are four image forming device IDs of “P1” to “P4”, and thus it is indicated that four image forming devices 2 operate in the processing system 1.

The characteristic data list 32, the similar data list 33, and the similarity degree list 34 are each also a list generated through the device attribute collection process, as with the device list 9. The method of generating the device list 9, the characteristic data list 32, the similar data list 33, and the similarity degree list 34 through the device attribute collection process and the contents of the characteristic data list 32, the similar data list 33, and the similarity degree list 34 will be described in detail later.

The image forming device 2 described above may be constituted using a computer 20. FIG. 5 illustrates an example of the configuration of an electrical system of the image forming device 2 constituted using the computer 20.

The computer 20 includes a central processing unit (CPU) 21 which is an example of a processor that implements the various functional sections illustrated in FIG. 2, a read only memory (ROM) 22 that stores a processing program that causes the computer 20 to function as the image forming device 2, a random access memory (RAM) 23 that is used as a temporary work area for the CPU 21, a non-volatile memory 24, and an input/output interface (I/O) 25. The CPU 21, the ROM 22, the RAM 23, the non-volatile memory 24, and the I/O 25 are connected to each other via a bus 26.

The non-volatile memory 24 is an example of a storage device that keeps stored information even if power supplied to the non-volatile memory 24 is blocked. While a semiconductor memory is used as an example of the non-volatile memory 24, a hard disk may also be used. The non-volatile memory 24 stores information that needs to be stored continuously even if power for the image forming device 2 is blocked, such as the host device attribute list 8, for example.

A communication unit 27, an input unit 28, a display unit 29, an image forming unit 30, and a facsimile unit 31, for example, are connected to the I/O 25.

The communication unit 27 is connected to the intranet 4, and includes a communication protocol for data communication with the different devices 2 and the user terminals 6.

The input unit 28 is a unit that receives an instruction from the user and notifies the CPU 21, and includes a button, a touch screen, a keyboard, and a pointing device, for example. The image forming device 2 according to the present exemplary embodiment includes at least a touch screen as the input unit.

The display unit 29 is an example of a unit that visually displays information processed by the CPU 21, and includes a liquid crystal display, an organic electro luminescence (EL) display, etc., for example. By way of example, a touch screen as an example of the input unit 28 is attached as superposed on the display unit 29. When an operator displayed at the location at which the touch screen is depressed is depressed by the user, an instruction correlated with the depressed operator is provided to the CPU 21. Operating an operator by depressing the operator through a touch screen is referred to as “selecting” the operator.

The image forming unit 30 is a unit that forms received image data on a recording medium in accordance with an instruction from the CPU 21. Any system may be used by the image forming unit 30 to form an image on a recording medium. Examples of the system include electrophotography, an inkjet system, offset lithography, etc.

The facsimile unit 31 is a unit that transmits and receives image data to and from a different facsimile device (not illustrated) through a facsimile line. The CPU 21 prints the image data received through the facsimile line on a recording medium using the image forming unit 30, or transfers the image data to the user terminal 6 designated as the destination.

Units to be connected to the I/O 25 are not limited to the various units illustrated in FIG. 5. Units needed to implement a function of the image forming device 2 are connected to the I/O 25 in accordance with the function.

Next, the device attribute collection process executed by each of the image forming devices 2 will be described.

FIG. 6 is a flowchart illustrating an example of the flow of the device attribute collection process executed by the CPU 21 of the image forming device 2 in the case where power for the image forming device 2 is turned on.

The processing program which prescribes the device attribute collection process is stored in advance in the ROM 22 of the image forming device 2, for example. The CPU 21 of the image forming device 2 reads the processing program stored in the ROM 22, and executes the device attribute collection process.

The host device attribute list 8 is stored in advance in the non-volatile memory 24 of each of the image forming devices 2 included in the processing system 1. The RAM 23 stores in advance the device list 9 that includes correlation between the image forming device ID of the host device 2 and the attribute ID, the device attribute name, and the value extracted from the host device attribute list 8 of the host device 2, and an empty similar data list 33 in which no information is set. As described already, a device attribute name represents a device attribute, and thus is occasionally referred to simply as a “device attribute”.

First, in step S10, the CPU 21 initializes a characteristic candidate data list (not illustrated). Specifically, the CPU 21 generates an empty characteristic candidate data list that includes no information in the RAM 23. Moreover, the CPU 21 acquires the host device attribute list 8 from the non-volatile memory 24, correlates the attribute ID, the device attribute name, and the value of each of the device attributes set in the host device attribute list 8, and sets such information to the characteristic candidate data list.

The device attribute name in the host device attribute list 8 and the device attribute name (referred to as a “display name”) in the characteristic candidate data list do not necessarily coincide with each other. The display name of a device attribute in the characteristic candidate data list is occasionally set by abbreviating a device attribute name in the host device attribute list 8 or changing a device attribute name in the host device attribute list 8 to a name that is easily perceivable for the user with reference to a conversion table (not illustrated) determined in advance. This is because the display name of a device attribute in the characteristic candidate data list will be displayed, as it is, on the operation screen 35, as described later. For example, the “booklet ejection tray” in the host device attribute list 8 is set in the characteristic candidate data list with its name changed to “booklet tray”.

In step S20, the CPU 21 broadcasts, from the communication unit 27, a request instruction for requesting device information to various information devices, including the different devices 2, connected to the intranet 4. In addition, the CPU 21 starts a timer after transmitting a request instruction. The timer to be started may be implemented using a timer function built in the CPU 21 in advance, for example.

The device information includes an IP address allocated to an information device that has received the request instruction and specific information (e.g. a MAC address) for identifying the information device, for example.

In step S30, the CPU 21 determines whether or not device information has been received. The process transitions to step S40 in the case where device information has been received.

Since the request instruction has been broadcast, device information is received also from information devices other than the image forming devices 2. Thus, in step S40, the CPU 21 determines whether or not the type of an information device that has transmitted the device information is the image forming device 2, that is, whether or not the device information has been received from the different device 2 which is the target device for the device attribute collection process, with reference to the specific information in the received device information. If the device information is not from the different device 2, the process transitions to step S30, and it is determined whether or not next device information has been received.

On the other hand, the process transitions to step S50 in the case where it is determined in the determination process in step S40 that the device information has been received from the different device 2.

In step S50, the CPU 21 transmits a device attribute request for requesting transmission of the host device attribute list 8 to the image forming device 2 to which the IP address included in the received device information is allocated. Consequently, the CPU 21 receives the host device attribute list 8 of the image forming device 2 from the image forming device 2 to which the IP address included in the device information is allocated. It is only necessary to see what device attributes the different device 2 has. Therefore, the CPU 21 may request only the device attributes and the values in the host device attribute list 8, rather than requesting the entire host device attribute list 8.

In step S60, the CPU 21 extracts the device attributes and the values from the host device attribute list 8 of the different device 2 acquired in step S50, and adds to the device list 9 the image forming device ID uniquely allocated to the different device 2 that has transmitted the host device attribute list 8 and the correlation between the device attributes and the values for each attribute ID prescribed in the host device attribute list 8 of the different device 2 represented by the image forming device ID and extracted from the host device attribute list 8.

After the process in step S60 is executed, the process transitions to step S30, and it is determined whether or not next device information has been received.

Thus, the processes in steps S30 to S60 are repeatedly executed by receiving device information from each of the different devices 2 included in the processing system 1, and the device list 9 such as that illustrated in FIG. 4 is generated through the process in step S60.

In the case where it is determined in the determination process in step S30 that device information has not been received, on the other hand, the process transitions to step S70.

The number of the information devices connected to the intranet 4 is occasionally varied. Since a request instruction for requesting device information has been broadcast in the process in step S20, the CPU 21 is not able to grasp the number of pieces of device information to be received in advance. Thus, the CPU 21 may determine that device information has been received from all the information devices connected to the intranet 4 in the case where a stand-by time determined in advance has elapsed since a request instruction for requesting device information is transmitted.

The stand-by time is a time set in advance through experimentation or computer simulation using the processing system 1, for example, as a time enough to receive device information from all the information devices, even if a maximum number of connectable information devices are connected to the intranet 4. The stand-by time is stored in advance in the non-volatile memory 24, for example.

Thus, in step S70, the CPU 21 determines whether or not the timer started in step S20 has counted the stand-by time. In the case where the timer indicates a value that is less than the stand-by time, the process transitions to step S30 since there is still a possibility that device information will be received, and it is determined whether or not next device information has been received.

In the case where the timer indicates a value that is equal to or more than the stand-by time, on the other hand, the process transitions to step S80 since there is no possibility that any more device information will be received.

In step S80, the CPU 21 executes a list generation process for generating a characteristic data list 32, a similar data list 33, and a similarity degree list 34 using the host device attribute list 8 stored in advance in the non-volatile memory 24 of the host device 2 and the device list 9 generated in the process in step S60. Then, the device attribute collection process is ended.

Next, the content of processes performed in the list generation process will be described in detail.

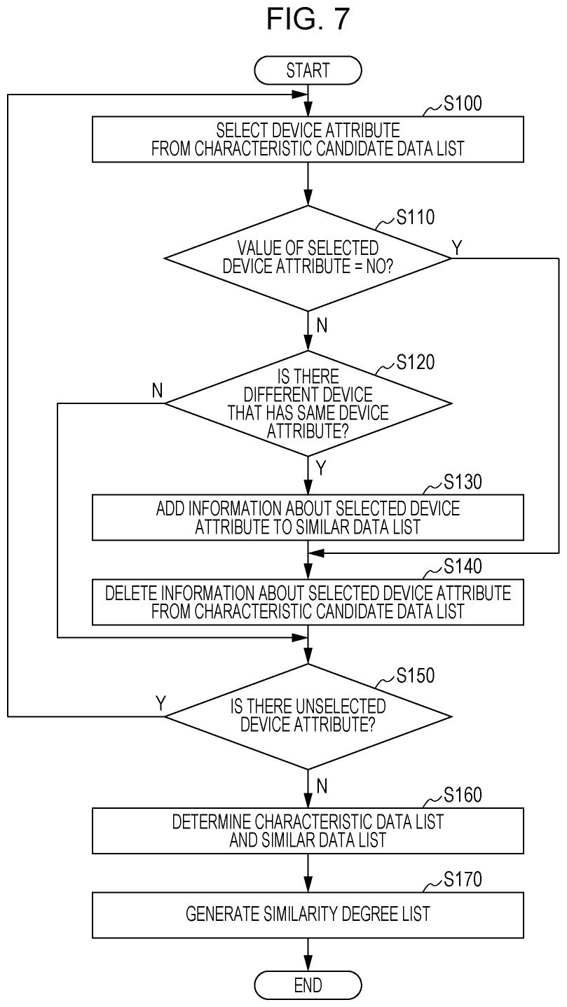

FIG. 7 is a flowchart illustrating an example of the flow of the list generation process executed in step S80 of the device attribute collection process illustrated in FIG. 6.

After the device information is received from each of the image forming devices 2 included in the processing system 1 and the generation of the device list 9 illustrated in FIG. 4 is completed, in step S100, the CPU 21 selects one device attribute from the characteristic candidate data list initialized in step S10 in FIG. 6. The device attribute selected in step S100 is referred to as a “selected device attribute”.

In step S110, the CPU 21 determines whether or not the value of the selected device attribute is “No”. In the case where the value of the selected device attribute is not “No”, it is meant that the host device 2 includes the selected device attribute, and therefore the process transitions to step S120.

In step S120, the CPU 21 determines whether or not there is a different device 2 that has the same device attribute as the selected device attribute with reference to the device list 9. The process transitions to step S130 in the case where there is a different device 2 that has the same device attribute as the selected device attribute.

In this case, the selected device attribute is not a characteristic device attribute that is not seen with the different device 2. Thus, in step S130, the CPU 21 adds, to the similar data list 33, the attribute ID of the selected device attribute, the display name of the selected device attribute, and the value of the selected device attribute in the characteristic candidate data list, that is, information about the selected device attribute, and the image forming device ID of the different device 2 with the selected device attribute, in correlation with each other. That is, the similar data list 33 is a list that is used to store a device attribute of the host device 2 that is also provided to the different device 2. In other words, the similar data list 33 is a list that indicates a device attribute that is replaceable with the different device 2 in place of the host device 2. A device attribute included in the similar data list 33 is called “similar information”, in contrast to the “characteristic information” which indicates a device attribute that is characteristic of the host device 2 compared to the different device 2.

In step S140, the CPU 21 deletes information about the selected device attribute from the characteristic candidate data list, since the selected device attribute is a device attribute also provided to the different device 2. Then, the process transitions to step S150. That is, the characteristic candidate data list is a list that is used to store a candidate for a device attribute of the host device 2 that is not provided to the different device 2. In other words, the characteristic candidate data list is a list that indicates a candidate for a device attribute that is executable only by the host device 2. A device attribute included in the characteristic candidate data list represents a candidate for characteristic information.

Also in the case where it is determined in the determination process in step S110 that the value of the selected device attribute is set to “No”, the CPU 21 deletes information about the selected device attribute from the characteristic candidate data list by executing the process in step S140. This is because the selected device attribute could not be characteristic information on the host device when the host device 2 does not include the selected device attribute.

In the case where it is determined in the determination process in step S120 that there is no different device 2 that has the same device attribute as the selected device attribute, on the other hand, the selected device attribute is a characteristic device attribute that is not seen with the different device 2. Thus, the process transitions to step S150 without executing the processes in steps S130 and S140. When a transition is made from step S120 to step S150, information about the selected device attribute is not deleted from the characteristic candidate data list, but remains as it is.

In step S150, the CPU 21 determines whether or not there is still an unselected device attribute that has not been selected in step S100 in the characteristic candidate data list. In the case where there is an unselected device attribute, the process transitions to step S100, and one device attribute is selected as a new selected device attribute from among the unselected device attributes included in the characteristic candidate data list. Then, the processes in steps S100 to S150 are repeatedly executed until it is determined in the determination process in step S150 that there is no unselected device attribute. Consequently, only device attributes that are characteristic of the host device 2 remain in the characteristic candidate data list, and device attributes also provided to the different device 2 are classified into the similar data list 33.

In the case where it is determined in the determination process in step S150 that there is no unselected device attribute in the characteristic candidate data list, on the other hand, the process transitions to step S160.

In this case, each of the device attributes of the host device 2 has been classified into the characteristic candidate data list or the similar data list 33. Therefore, in step S160, the CPU 21 determines the characteristic candidate data list as the characteristic data list 32, and also determines the content of the similar data list 33.

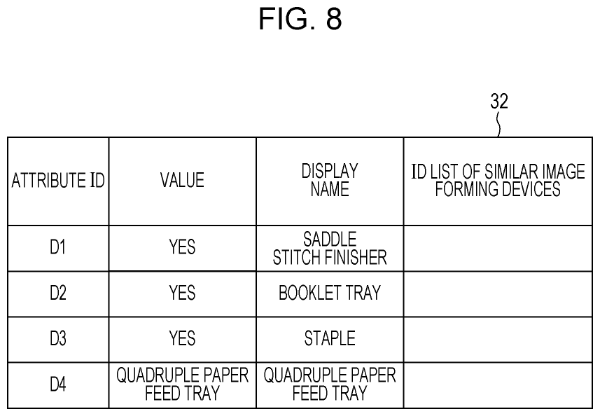

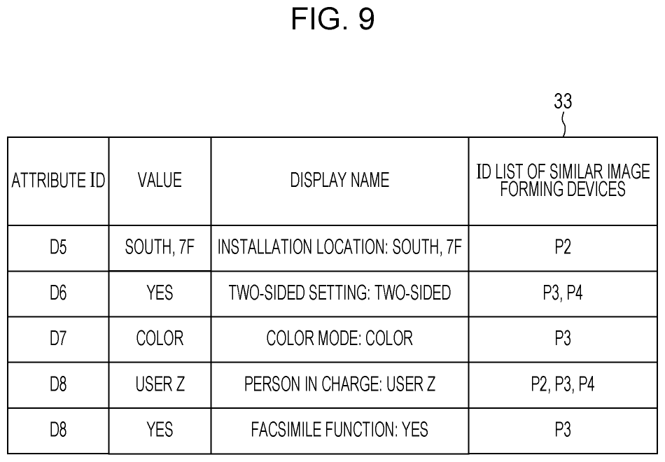

FIG. 8 illustrates an example of the characteristic data list 32 generated from the host device attribute list 8 illustrated in FIG. 3 and the device list 9 illustrated in FIG. 4. FIG. 9 illustrates an example of the similar data list 33 generated from the host device attribute list 8 illustrated in FIG. 3 and the device list 9 illustrated in FIG. 4.

The characteristic data list 32 and the similar data list 33 include an “ID list of similar image forming devices” column. The image forming device IDs of the different devices 2 with the corresponding device attribute are set in the column of the ID list of similar image forming devices. There are no different devices 2 with device attributes included in the characteristic data list 32. Thus, as illustrated in FIG. 8, the column of the ID list of similar image forming devices in the characteristic data list 32 is vacant. That is, no image forming device IDs are set in the column of the ID list of similar image forming devices in the characteristic data list 32.

On the other hand, the image forming device IDs of the different devices 2 with the corresponding device attribute are set in the column of the ID list of similar image forming devices in the similar data list 33.

In step S170, the CPU 21 calculates the degree of similarity between the host device 2 and each of the different devices 2, and generates a similarity degree list 34 that represents the calculation results in the RAM 23.

Specifically, the CPU 21 calculates the degree of similarity between the host device 2 and the different devices 2 from the status of overlap of their device attributes. The degree of similarity between the host device 2 and the different devices 2 is higher as the degree of overlap of their device attributes is higher. The degree of similarity is represented by a numerical value of 0 or more and 1 or less, for example. In the present exemplary embodiment, the degree of similarity is higher as the numerical value is larger. As a matter of course, however, the degree of similarity may be higher as the numerical value is smaller.

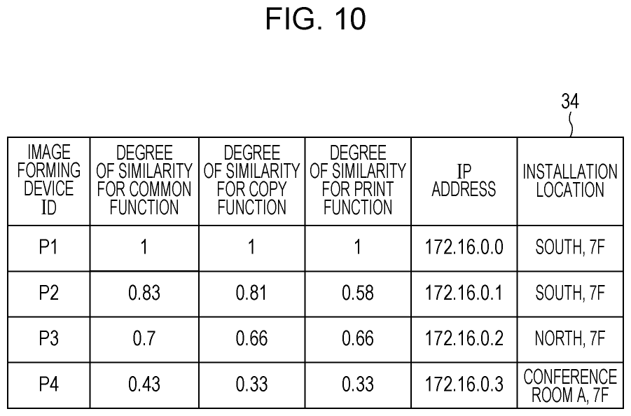

FIG. 10 illustrates an example of the similarity degree list 34.

Information about the device attributes of the host device 2 is obtained from the host device attribute list 8. Information about the device attributes of each of the different devices 2 included in the processing system 1 is obtained from the device list 9. Thus, the CPU 21 acquires the device attributes of the host device 2 and the device attributes of the different devices 2 from the host device attribute list 8 and the device list 9, respectively, and calculates the degree of similarity between the host device 2 and the different devices 2.

In the case where the device list 9 also includes information about the device attributes of the host device 2, as in the image forming device 2 according to the present exemplary embodiment, information about the device attributes of the host device 2 and each of the different devices 2 may be acquired from the device list 9 alone.

The degree of similarity between the host device 2 and the different devices 2 is calculated using a content-based filtering method in which a degree of similarity is calculated by calculating characteristic vectors that represent characteristic amounts of device attributes for each image forming device 2 with reference to the device list 9 and performing a weighted product-sum operation for each device attribute of a cosine degree of similarity of characteristic vectors for device attributes of the same type. The degree of similarity between the host device 2 and the different devices 2 may be calculated using a method of stochastically expressing a degree of similarity such as a topic model such as latent Dirichlet allocation (LDA), for example, rather than the content-based filtering.

The CPU 21 uses the value of the weight assignment set for each function set in the host device attribute list 8 as the value of the weight assignment that is used to calculate a degree of similarity. Thus, as illustrated in FIG. 10, the degree of similarity between the host device 2 and the different devices 2 is calculated for each function, which results in a degree of similarity for common function, a degree of similarity for copy function, and a degree of similarity for print function.

“P1” in the image forming device ID column in FIG. 10 is the image forming device ID of the host device 2. In this manner, the similarity degree list 34 may include the degree of similarity between the host device 2 and the host device 2. As a matter of course, the degree of similarity between the host device 2 and the host device 2 is the degree of similarity between identical image forming devices 2, and therefore the degree of similarity for each function is “1”, which indicates the highest degree of similarity.

The similarity degree list 34 may include not only the degree of similarity but also information such as the IP address and the installation location of each image forming device 2, for example, as necessary.

When the list generation process is ended as described above, the device attribute collection process illustrated in FIG. 6 is ended.

While the device attribute collection process is executed in the case where power for the image forming device 2 is turned on in the example described above, the CPU 21 may execute the device attribute collection process at a prescribed timing, such as a timing indicated by the person in charge, a timing when a connection request is received from the user terminal 6, a timing when user authentication (a log-in operation) is performed in order for the user to use the image forming device 2 from the local operation screen 35B, and at intervals set in advance, for example.

In the example of the list generation process illustrated in FIG. 7, the selected device attribute is not included in the characteristic data list if there is at least one different device 2 that has the same device attribute as the selected device attribute in step S120. However, the selected device attribute may be considered as a device attribute that is characteristic of the host device 2, when seen from the entire processing system 1, when there are 100 image forming devices 2 included in the processing system 1 and there is only one different device 2 that has the same device attribute as the selected device attribute, for example, even if there is a different device 2 that has the same device attribute as the selected device attribute.

Thus, the CPU 21 may include a device attribute of the host device 2, the number of different devices 2 that have the device attribute being equal to or less than a number determined in advance, in the characteristic data list 32. Alternatively, the CPU 21 may include a device attribute of the host device 2, the proportion of the number of image forming devices 2 that have the device attribute to the number of all the image forming devices 2 included in the processing system 1 being equal to or less than a proportion determined in advance, in the characteristic data list 32.

In the device attribute collection process illustrated in FIG. 6, each of the image forming devices 2 included in the processing system 1 individually generates a device list 9. However, one of the image forming devices 2 included in the processing system 1 may generate a device list 9 and transmit the generated device list 9 to the other image forming devices 2. Alternatively, a device list 9 generated by one of the image forming devices 2 included in the processing system 1 may be shared and referenced by the image forming devices 2.

In this case, it is only necessary that image forming devices 2 that do not generate a device list 9 should perform the list generation process in step S80 in the device attribute collection process illustrated in FIG. 6 using a device list generated by a different image forming device 2. On the other hand, the image forming device 2 that generates a device list 9 performs the device attribute collection process at intervals set in advance, and regularly updates the device list 9.

Next, operation of the image forming device 2 for the case where the user has started use of the image forming device 2 will be described. Use of the image forming device 2 is started by the user performing an operation (referred to as a “local operation”) by touching the input unit 28 of the image forming device 2 or by the user performing an operation (referred to as a “remote operation”) by connecting the user terminal 6 to the image forming device 2, for example. While an example in which a remote operation is performed from the user terminal 6 through the WAN 7 will be described here by way of example, an example in which a local operation is performed will also be described, as appropriate, mainly for differences from operation for the case where a remote operation is performed.

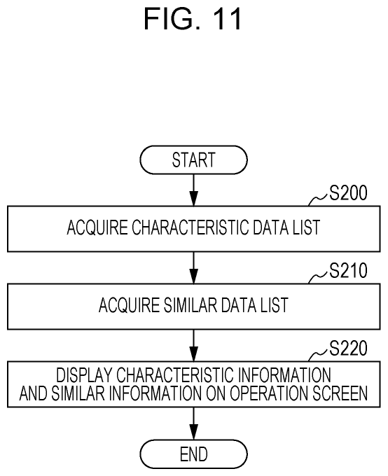

FIG. 11 is a flowchart illustrating an example of the flow of a display process for the operation screen 35 executed by the CPU 21 of the image forming device 2 in the case where use of the image forming device 2 is started.

The processing program which prescribes the display process is stored in advance in the ROM 22 of the image forming device 2, for example. The CPU 21 of the image forming device 2 reads the processing program stored in the ROM 22, and executes the display process.

In step S200, the CPU 21 acquires a characteristic data list 32 from the RAM 23.

In step S210, the CPU 21 acquires a similar data list 33 from the RAM 23.

In step S220, the CPU 21 generates an operation screen 35 in which the device attributes (i.e. characteristic information) included in the characteristic data list 32 acquired in step S200 and the device attributes (i.e. similar information) included in the similar data list 33 acquired in step S210 are displayed so as to be distinguishable from each other, and displays the generated operation screen 35 on a display device of a device from which the user is operating. The display device of the device from which the user is operating is the display unit 29 of the image forming device 2 operated by the user in the case where the user starts use of the image forming device 2 by operating the input unit 28. On the other hand, the display device of the device from which the user is operating is the display of the user terminal 6 operated by the user in the case where the user starts use of the image forming device 2 from the user terminal 6. That is, the CPU 21 transmits the operation screen 35 on which the characteristic information and the similar information are displayed to the user terminal 6 which has requested an operation on the host device 2 through the WAN 7 in the case where an operation of the image forming device 2 is received from the user terminal 6.

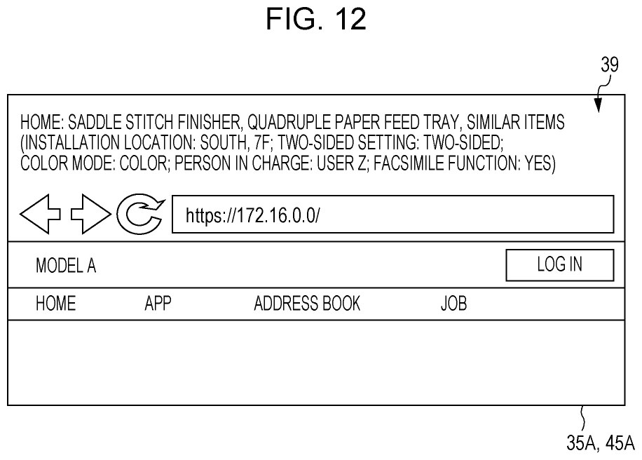

FIG. 12 illustrates an example of a remote operation screen 35A (referred to as a “home screen 45A”) to be displayed first in the case where use of the image forming device 2 is started. The home screen 45A is a screen for making settings and performing operations about the common function of the image forming devices 2.

The characteristic information and the similar information are displayed in a region 39 at the upper part of the home screen 45A. The similar information includes device attributes indicated in parentheses that follow the title “Similar Items”. The other device attributes represent the characteristic information. The manner of displaying the characteristic information and the similar information is not limited to that in the example in FIG. 12, and the characteristic information and the similar information may be displayed in any manner as long as the two kinds of information are distinguishable from each other.

There are no restrictions on the display positions of the characteristic information and the similar information, and the positions in the region 39 are not limiting. For example, the characteristic information and the similar information may be displayed in a pop-up screen (not illustrated) displayed as superposed on the front side of the home screen 45A, or the characteristic information may be displayed in a pop-up screen and the similar information may be displayed on the home screen 45A. A confirmation button (not illustrated) is displayed in the pop-up screen so that the pop-up screen is closed when the user selects the confirmation button.

While the characteristic data list 32 illustrated in FIG. 8 includes saddle stitch finisher, booklet tray, staple, and quadruple paper feed tray as the characteristic information, only saddle stitch finisher and quadruple paper feed tray are displayed as the characteristic information in the example of the home screen 45A illustrated in FIG. 12. This is because the home screen 45A which is used to make settings and perform operations about the common function displays only characteristic information associated with the home screen 45A, among the characteristic information included in the characteristic data list 32.

In this manner, the CPU 21 may display, on the remote operation screen 35A, only characteristic information associated with functions to be subjected to settings and operations on the remote operation screen 35A being displayed, rather than displaying all the characteristic information included in the characteristic data list 32 on the remote operation screen 35A. That is, the CPU 21 changes the characteristic information to be displayed on the remote operation screen 35A in accordance with the function to be executed by the user.

It is possible to determine which function the characteristic information is associated with by referencing the host device attribute list 8. It is seen, from the example of the host device attribute list 8 illustrated in FIG. 3, that the saddle stitch finisher is characteristic information associated with only the common function, since the saddle stitch finisher has a weight assignment of “1” for the common function and a weight assignment of “0” for both the copy function and the print function. That is, in the host device attribute list 8, characteristic information is not associated with a certain function if the characteristic information has a weight assignment of “0” for the function. On the other hand, characteristic information is associated with a certain function for a device attribute set in the characteristic information if the characteristic information has a weight assignment of other than “0” for the function.

As a matter of course, the CPU 21 may display all the characteristic information included in the characteristic data list 32 on the remote operation screen 35A, irrespective of the function to be executed by the user.

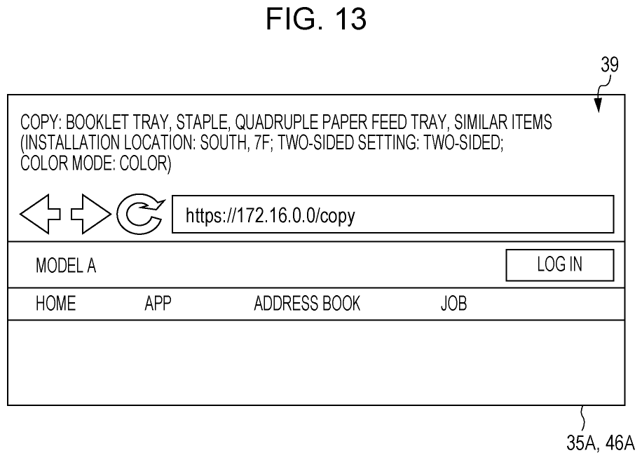

FIG. 13 illustrates an example of the remote operation screen 35A (copy screen 46A) for making settings and performing operations about the copy function.

As seen in the example of the host device attribute list 8 illustrated in FIG. 3, the characteristic information on the saddle stitch finisher, among the characteristic information included in the characteristic data list 32, has a weight assignment for the copy function set to “0”. Therefore, booklet tray, staple, and quadruple paper feed tray are displayed on the copy screen 46A as the characteristic information.

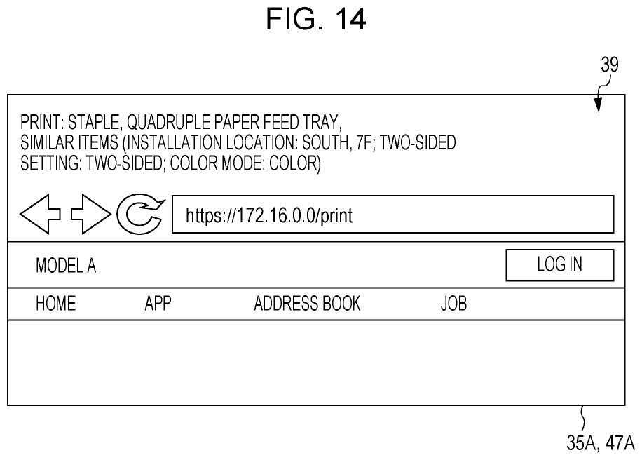

FIG. 14 illustrates an example of the remote operation screen 35A (print screen 47A) for making settings and performing operations about the print function.

As seen in the example of the host device attribute list 8 illustrated in FIG. 3, the characteristic information on the saddle stitch finisher and the booklet tray, among the characteristic information included in the characteristic data list 32, has a weight assignment for the print function set to “0”. Therefore, staple and quadruple paper feed tray are displayed on the print screen 47A as the characteristic information.

Switching between the remote operation screens 35A corresponding to the functions may be made by an operation from the home screen 45A. The functions of the image forming device 2 other than the common function, namely the copy function and the print function, are indicated as “Apps” on the remote operation screen 35A.

In the case where there are a plurality of pieces of characteristic information to be displayed on the remote operation screen 35A, further, the CPU 21 may display the characteristic information in accordance with the order determined in advance for each of the device attributes set in the characteristic information.

In the host device attribute list 8, as illustrated in FIG. 3, the display priority degree of the device attribute is set for each standard function of the image forming device 2. Thus, the CPU 21 may determine the order of display of the characteristic information in accordance with the display priority degree of the device attribute set in the characteristic information.

For example, in the case where characteristic information is to be displayed on the home screen 45A illustrated in FIG. 12, the saddle stitch finisher has a display priority degree for common function of “98”, and the quadruple paper feed tray has a display priority degree for common function of “97”, as seen in the example of the host device attribute list 8 illustrated in FIG. 3. Thus, the saddle stitch finisher is displayed first, and the quadruple paper feed tray is displayed subsequently.

As a matter of course, the CPU 21 may display the characteristic information on the remote operation screen 35A in accordance with the arrangement order in the characteristic data list 32, or display the characteristic information on the remote operation screen 35A in a random arrangement order. Alternatively, the CPU 21 may display the characteristic information on the remote operation screen 35A in the descending order of the frequency of use with reference to the frequency of use of the device attributes recorded in history information.

While the characteristic information on the image forming device 2 is displayed with character strings on the remote operation screen 35A for each function illustrated in FIGS. 12 to 14, the CPU 21 may display the characteristic information on the remote operation screen 35A in correlation with an image (referred to as a “mimic image 36”) that simulates the appearance of the host device 2.

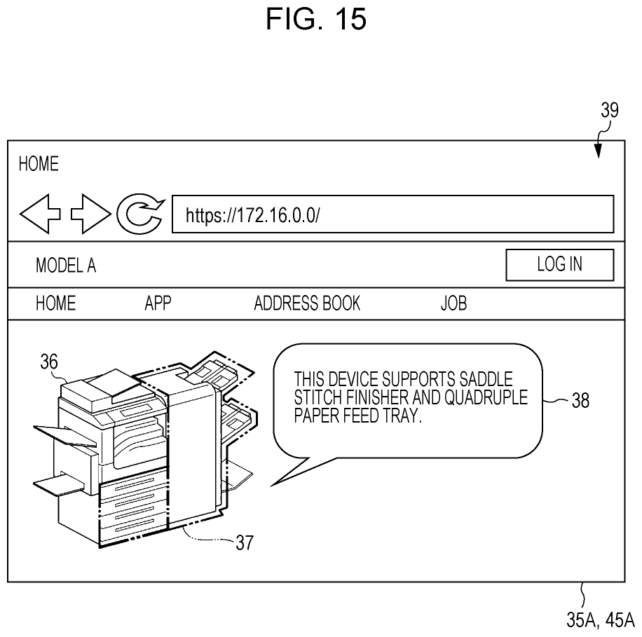

FIGS. 15 to 17 each illustrate a display example of the remote operation screen 35A in which the characteristic information in the remote operation screen 35A illustrated in FIGS. 12 to 14 is correlated with the mimic image 36. On the remote operation screen 35A in FIGS. 15 to 17, the characteristic information and the mimic image 36 are correlated with each other by displaying the characteristic information displayed in the region 39 of the remote operation screen 35A illustrated in FIGS. 12 to 14 in a balloon 38 that points to the mimic image 36. The correlation between the characteristic information and the mimic image 36 is not limited to that in the example described above, and the characteristic information and the mimic image 36 may be correlated with each other using a leader line.

In the case where the characteristic information is displayed on the remote operation screen 35A in correlation with the mimic image 36, further, the CPU 21 may clearly indicate a position in the host device 2 associated with the characteristic information in the mimic image 36 if the “presence of display in image” column for the device attribute set in the characteristic information is set to “Yes” with reference to the host device attribute list 8 illustrated in FIG. 3.

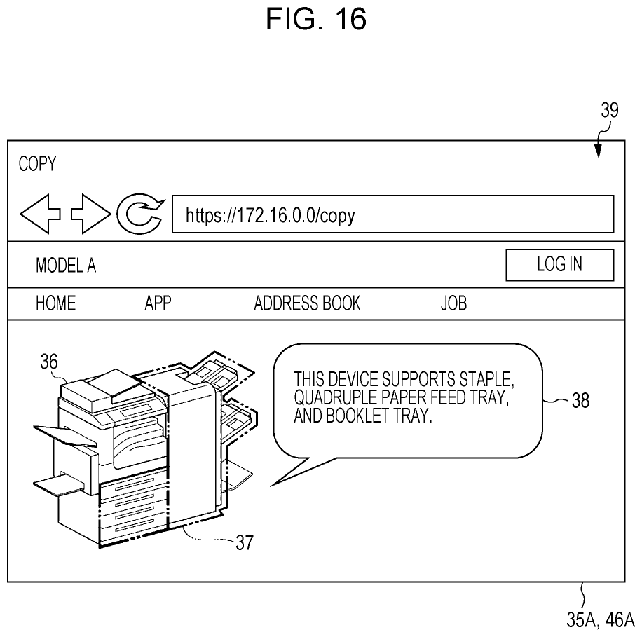

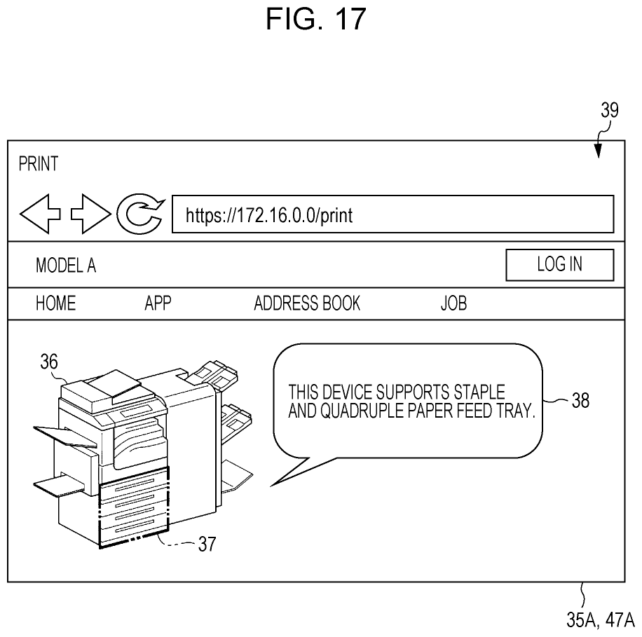

In the example of the host device attribute list 8 illustrated in FIG. 3, the “presence of display in image” column for the saddle stitch finisher, the booklet tray, and the paper feed tray configuration is set to “Yes”. Thus, positions corresponding to the saddle stitch finisher and the quadruple paper feed tray are clearly indicated in the mimic image 36 using frame lines 37 in the example of the home screen 45A illustrated in FIG. 15. Positions corresponding to the quadruple paper feed tray and the booklet tray are clearly indicated in the mimic image 36 using frame lines 37 in the example of the copy screen 46A illustrated in FIG. 16. A position corresponding to the quadruple paper feed tray is clearly indicated in the mimic image 36 using a frame line 37 in the example of the print screen 47A illustrated in FIG. 17.

The CPU 21 is also able to display the similar information on the remote operation screen 35A in the same manner as the display of the characteristic information.

That is, the CPU 21 may display all the similar information included in the similar data list 33 on the remote operation screen 35A, or may change the similar information to be displayed on the remote operation screen 35A in accordance with the function to be executed by the user. In the case where there are a plurality of pieces of similar information to be displayed on the remote operation screen 35A, the CPU 21 may display the similar information in accordance with the order determined in advance for each of the device attributes set in the similar information. The CPU 21 may display the similar information on the remote operation screen 35A in correlation with the mimic image 36. In this case, the CPU 21 may clearly indicate a position in the host device 2 associated with the similar information in the mimic image 36.

It is not necessary that the CPU 21 should display the characteristic information and the similar information on the remote operation screen 35A in the same manner as each other. For example, the similar information may be displayed in the region 39 of the remote operation screen 35A, and the characteristic information may be displayed in the balloon 38.

While a display example of the characteristic information and the similar information to be displayed on the remote operation screen 35A has been described so far, the local operation screen 35B is displayed on the display unit 29 in place of the remote operation screen 35A in the case where a local operation is performed by the user.

The screen size of the display unit 29 is often smaller than the screen size of the display of the user terminal 6. Thus, it is difficult to display the local operation screen 35B in the same layout as the remote operation screen 35A, and therefore the layout on the local operation screen 35B is preferably different from the layout of the remote operation screen 35A.

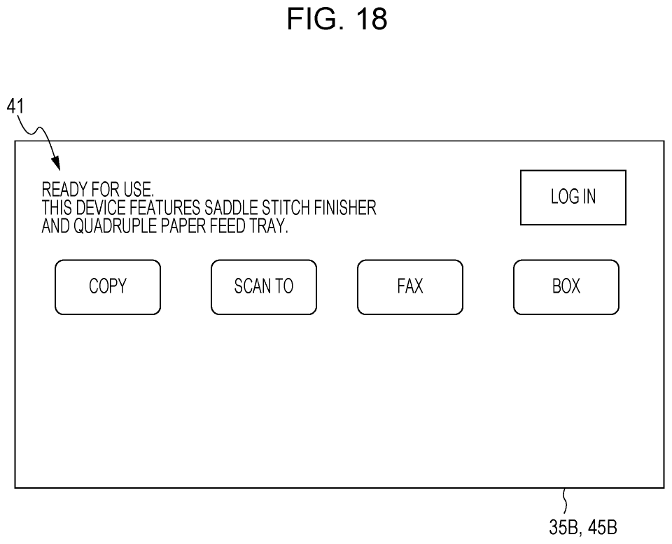

FIG. 18 illustrates an example of the local operation screen 35B to be displayed first, that is, a home screen 45B, in the case where use of the image forming device 2 has been started through a location operation by the user. The home screen 45B is a screen for making settings and performing operations about the common function of the image forming devices 2.

In the example of the home screen 45B illustrated in FIG. 18, the characteristic information is displayed in a region 41 located at the upper part of the home screen 45B. The CPU 21 may also display the similar information in addition to the characteristic information in the case where the region 41 is large enough. That is, the CPU 21 displays at least the characteristic information on the local operation screen 35B.

The manner of display of the characteristic information and the similar information applied to the remote operation screen 35A is also applied to the local operation screen 35B.

That is, the CPU 21 may change the characteristic information and the similar information to be displayed on the local operation screen 35B in accordance with the function to be executed by the user, rather than displaying all the characteristic information and the similar information on the local operation screen 35B. In the case where there are a plurality of pieces of characteristic information and similar information to be displayed on the local operation screen 35B, the CPU 21 may display the characteristic information and the similar information in accordance with the order determined in advance for each of the device attributes set in the characteristic information and the similar information. The CPU 21 may display the characteristic information and the similar information on the local operation screen 35B in correlation with the mimic image 36 in the case where there is a margin in the layout of the local operation screen 35B.

<Alternative Process by Image Forming Device in Case of Trouble>

The image forming device 2 occasionally determines that a designated function is not executable in the case where a trouble related to the designated function has been detected when the user attempts to execute the designated function. In such a case, the image forming device 2 not only simply indicates on the operation screen 35 that a trouble has occurred, but also displays on the operation screen 35 information about a different device 2 that may be able to execute the designated function, among the different devices 2.

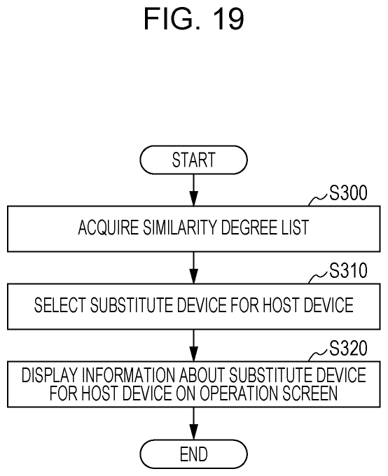

FIG. 19 is a flowchart illustrating an example of the flow of a substitute process to be executed by the CPU 21 of the image forming device 2 in the case where a trouble that renders a designated function unexecutable has been detected.

The processing program which prescribes the substitute process is stored in advance in the ROM 22 of the image forming device 2, for example. The CPU 21 of the image forming device 2 reads the processing program stored in the ROM 22, and executes the substitute process.

It is assumed that the similarity degree list 34 illustrated in FIG. 10 is stored in the RAM 23 of the image forming device 2.

First, in step S300, the CPU 21 acquires the similarity degree list 34 from the RAM 23.

In step S310, the CPU 21 selects an image forming device 2 with the highest degree of similarity related to the device attributes to the host device 2, among the different devices 2, as a substitute device for the host device 2 with reference to the similarity degree list 34 acquired in step S300.

As illustrated in FIG. 10, the degree of similarity in the similarity degree list 34 is set for each of the functions of the image forming devices 2. Thus, the CPU 21 calculates a degree of similarity between the host device 2 and each of the different devices 2 from the degree of similarity for each of the functions in accordance with a computation formula determined in advance. Specifically, the CPU 21 may determine the sum of the degrees of similarity for the various functions as the degree of similarity, or may determine the product of the degrees of similarity for the various functions as the degree of similarity.

The CPU 21 selects a different device 2, with which the highest degree of similarity has been obtained, among the degrees of similarity that have been calculated, as the substitute device for the host device 2.

In step S320, the CPU 21 displays an operation screen 35 that includes information about the substitute device for the host device 2 selected in step S310 on the display device of the device from which the user is operating. Then, the substitute process is ended.

The information about the substitute device for the host device 2 includes information for specifying which of the image forming devices 2 should be used as the substitute device for the image forming device 2 that the user is attempting to use. The IP address and the installation location of the image forming device 2 as the substitute device are examples of the information about the substitute device for the host device 2.

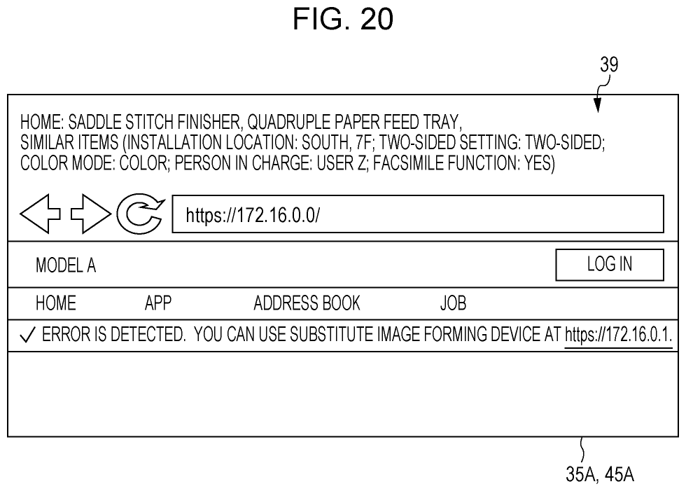

FIG. 20 illustrates an example of the remote operation screen 35A, specifically the home screen 45A, that includes information about the substitute device for the image forming device 2 that the user is attempting to use. In the case where the user is performing a remote operation, the user is operating the image forming device 2 through the intranet 4 or the WAN 7. Thus, the CPU 21 preferably displays, on the remote operation screen 35A, the IP address of the image forming device 2 as the substitute device as the information about the substitute device for the image forming device 2.

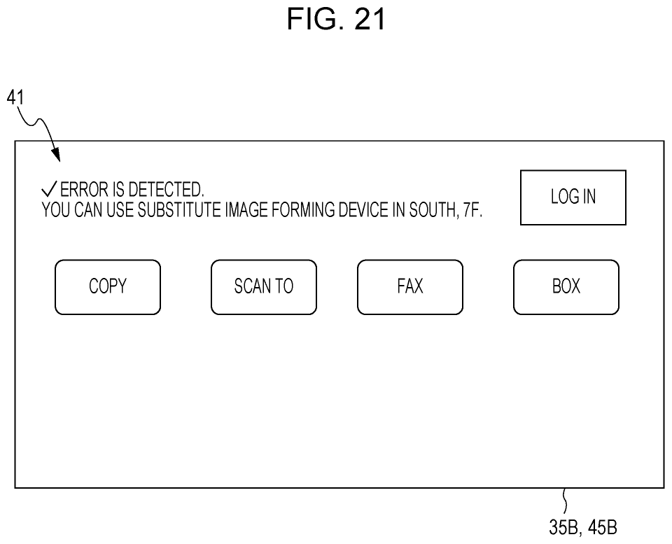

Meanwhile, FIG. 21 illustrates an example of the local operation screen 35B, specifically the home screen 45B, that includes information about the substitute device for the image forming device 2 that the user is attempting to use. In the case where the user is performing a local operation, the user is in the building 5 in which the image forming device 2 is installed, and thus is able to move to a location at which the substitute device for the image forming device 2 is located. Thus, the CPU 21 preferably displays, on the local operation screen 35B, the installation location of the image forming device 2 as the substitute device as the information about the substitute device for the image forming device 2.

It is also conceivable that the user who has performed a local operation connects the user terminal 6 to the intranet 4 to perform a remote operation on the substitute device from the user terminal 6 since the location at which the substitute device is located is so far. Thus, the user is also able to select, from the local operation screen 35B, information about the image forming device 2 as the substitute device to be displayed on the local operation screen 35B. For example, even in the case where the user is performing a local operation, the CPU 21 may display the IP address of the image forming device 2 as the substitute device on the local operation screen 35B, in place of or in addition to the installation location of the image forming device 2 as the substitute device, on the basis of an instruction from the user.

While a substitute device for an image forming device 2, with which a trouble has occurred, is selected using the degree of similarity for each image forming device 2, it is also considered that it is only necessary that device attributes related to the function that the user is attempting to use should be similar, and that it is not necessary that device attributes related to the other functions should be similar.

Thus, in step S310 of the substitute process illustrated in FIG. 19, the CPU 21 may select a substitute device for the host device 2 using the degree of similarity for each function designated by the user, rather than selecting a substitute device for the host device 2 using the degree of similarity for each image forming device 2.

Specifically, in the case where a trouble related to the print function is detected when the user is attempting to execute the print function, the CPU 21 may select an image forming device 2 with the highest degree of similarity for the print function, which is the function designated by the user, among the different devices 2, as the substitute device for the host device 2.

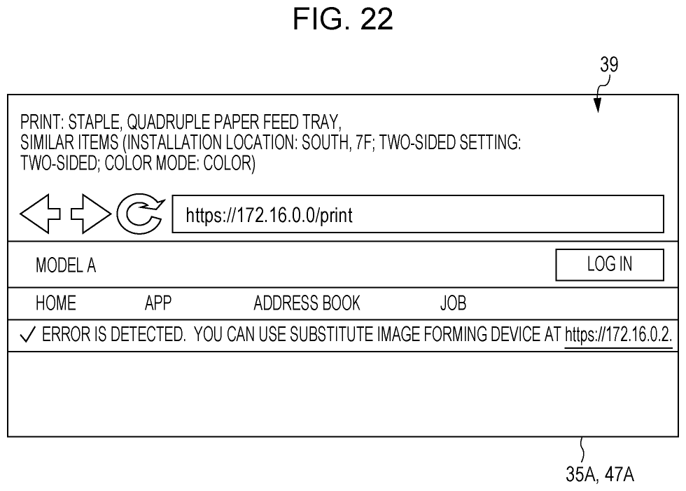

FIG. 22 illustrates an example of the remote operation screen 35A, specifically the print screen 47A, that includes information about the substitute device for the image forming device 2, the print function of which the user is attempting to use. In the similarity degree list 34 illustrated in FIG. 10, the image forming device 2 represented by an image forming device ID of “P3” has the highest degree of similarity for the print function other than the host device 2 (the image forming device 2 represented by an image forming device ID of “P1”). Thus, the CPU 21 acquires “172.16.0.2”, which is the IP address of the image forming device 2 represented by an image forming device ID of “P3”, from the similarity degree list 34, and displays the acquired IP address on the print screen 47A in FIG. 22.

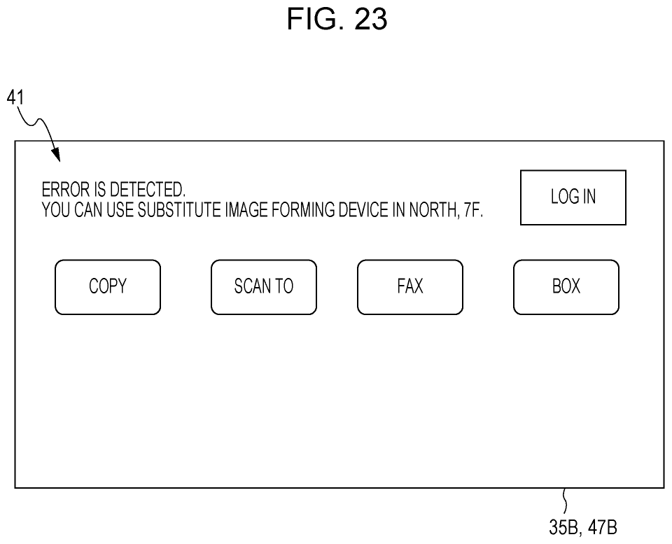

Meanwhile, FIG. 23 illustrates an example of the local operation screen 35B, specifically a print screen 47B, that includes information about the substitute device for the image forming device 2, the print function of which the user is attempting to use. The CPU 21 acquires “north, 7F”, which is the installation location of the image forming device 2 with the highest degree of similarity for the print function and represented by an image forming device ID of “P3”, from the similarity degree list 34, and displays the acquired installation location on the print screen 47B in FIG. 23.

In step S310 of the substitute process in FIG. 19, the CPU 21 may collect information about the operation status from each of the different devices 2 and, in the case where the selected substitute device for the host device 2 is being used, sequentially perform a process of selecting an image forming device 2 with the second highest degree of similarity, next to the image forming device 2 selected as the substitute device for the host device 2, as the substitute device for the host device 2.

In the case where a substitute device for the image forming device 2 is selected using a degree of similarity, there may be a situation in which there are a plurality of image forming devices 2 with the same degree of similarity. In such a case, the CPU 21 may select, as the substitute device for the host device 2, an image forming device 2 that allows selecting a setting value that is the same as a setting value selected by the user for the function designated by the user, among the image forming devices 2 with the same degree of similarity.

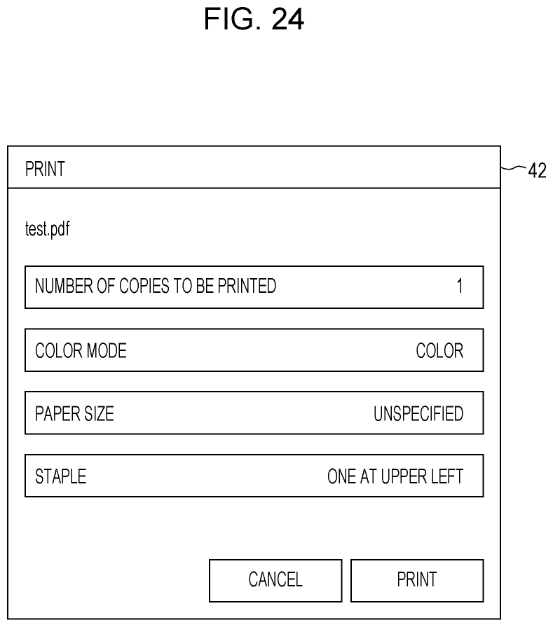

FIG. 24 illustrates an example of a setting screen 42 on which settings for operation related to the print function are made. The setting screen 42 is a screen to be displayed on the display device of the device from which the user is operating when the user operates the operation screen 35.

For example, it is assumed that the user has selected a “Print” button for executing the print function with the setting for staple changed from “None”, which is the default value, to “One at upper left” and with the other settings (settings for number of copies to be printed, color mode, and paper size in the example in FIG. 24) left at the default value. In such a case, the CPU 21 selects, as the substitute device for the host device, an image forming device 2 that enables selecting “One at upper left” as the setting value for staple, among the image forming devices with the same degree of similarity. What setting values are selectable with the different devices 2 may be acquired from the different devices 2 together with the host device attribute list 8 in step S50 of the device attribute collection process illustrated in FIG. 6.

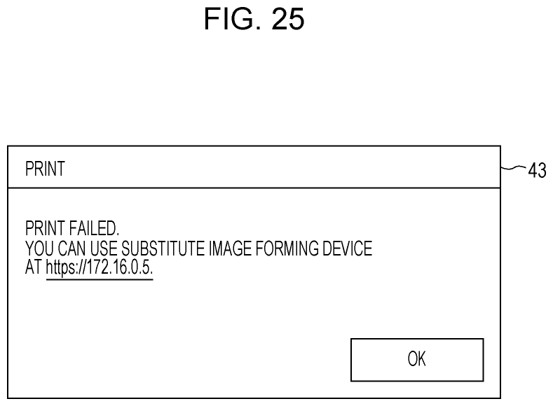

FIG. 25 illustrates an example of a dialog 43 that displays information about the image forming device 2 that allows selecting a setting value that is the same as a setting value selected by the user in the case where the user has selected the “Print” button on the setting screen 42 in FIG. 24.

The CPU 21 may display the dialog 43 on the display device of the device from which the user is operating at the timing when the user has changed a setting value for a setting item related to the designated function (at the timing when the setting value for staple has been changed from “None” to “One at upper left” in the example in FIG. 24), rather than displaying the dialog 43 on the display device of the device from which the user is operating after the user selects the “Print” button.

The CPU 21 may select, as the substitute device for the host device 2, an image forming device 2 with the highest degree of similarity, among the image forming devices 2 that allow selecting a setting value that is the same as a setting value selected by the user for the function designated by the user.

While the characteristic information and the similar information on the image forming device 2 are displayed on the operation screen 35 that is displayed along with use of the image forming device 2 in the example described so far, the scene in which the characteristic information and the similar information on the image forming device 2 are displayed is not limited to the time when the image forming device 2 is operated.

For example, in order to use a new image forming device 2 that has not been used, among a plurality of image forming devices 2, it is necessary to install a driver for the new image forming device 2 in the user terminal 6. In the case where the driver is installed in the user terminal 6 at a remote location, however, the user is not able to visually see the actual image forming device 2, and may not be able to fully grasp what device configuration the new image forming device 2 has.

Thus, the characteristic information and the similar information on the image forming device 2 may be displayed on a select screen 44 for installing the driver for the image forming device 2.

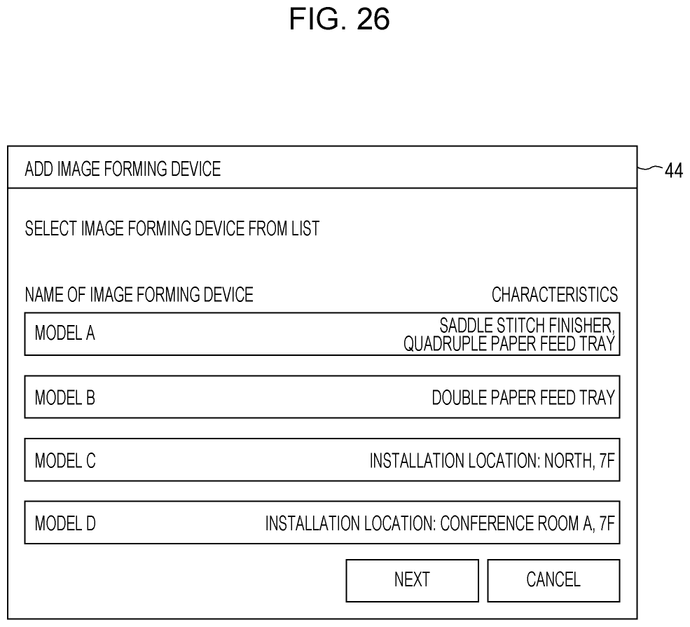

FIG. 26 illustrates an example of the select screen 44 for installing the driver for the image forming device 2. While only the characteristic information on the image forming device 2 is displayed in the example illustrated in FIG. 26, it is to be understood that the similar information may also be displayed together.

The manner of notifying the user of the characteristic information and the similar information on the image forming device 2 is not limited to displaying the characteristic information and the similar information on the operation screen 35 or the select screen 44. For example, the CPU 21 may output the characteristic information and the similar information on the image forming device 2 with a sound from the device from which the user is operating. Alternatively, the CPU 21 may print the characteristic information and the similar information on the image forming device 2 on a recording medium.

While an aspect of the processing apparatus has been described above using an exemplary embodiment, the disclosed aspect of the processing apparatus is exemplary, and the aspect of the processing apparatus is not limited to the scope of description of the exemplary embodiment. A variety of modifications and alterations may be made to the exemplary embodiment without departing from the scope and spirit of the present disclosure. Such modified or altered forms also fall within the technical scope of the present disclosure. For example, the internal order of the device attribute collection process illustrated in FIG. 6, the list generation process illustrated in FIG. 7, the display process for the operation screen 35 illustrated in FIG. 11, and the substitute process illustrated in FIG. 19 may be changed without departing from the scope and spirit of the present disclosure.

In the exemplary embodiment described above, the various processes are implemented using software, by way of example. However, processes that are equivalent to those of the flowcharts illustrated in FIGS. 6, 7, 11, and 19 may be implemented using hardware. In this case, the processes are performed at an increased speed compared to the case where the processes are implemented using software.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the exemplary embodiment described above, the processing program is stored in the ROM 22. However, the location of storage of the processing program is not limited to the ROM 22. The processing program according to the present disclosure may be provided as stored in a storage medium that is readable by the computer 20. For example, the processing program may be provided as stored in an optical disk such as a compact disk read only memory (CD-ROM) and a digital versatile disk read only memory (DVD-ROM). Alternatively, the processing program may be provided as stored in a portable semiconductor memory such as a Universal Serial Bus (USB) memory and a memory card. The ROM 22, the non-volatile memory 24, the CD-ROM, the DVD-ROM, the USB memory, and the memory card are examples of a non-transitory storage medium.

Further, the image forming device 2 as an example of the processing apparatus may download the processing program from an external device (not illustrated) connected to the intranet 4 or the WAN 7 through the communication unit 27, and store the downloaded processing program in a storage device. In this case, the CPU 21 of the image forming device 2 reads from the storage device the processing program downloaded from the external device, and executes the various processes.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A processing apparatus comprising:
a processor configured to:
reference host device information that represents device attributes provided to a host device and different device information that represents device attributes provided to a different device; and
notify a user that uses the host device of device attributes of the host device that are not provided to the different device as characteristic information on the host device.

2. The processing apparatus according to claim 1,
wherein the processor is configured to notify the user that uses the host device of a device attribute represented by the host device information, a number of the different devices that have the device attribute being equal to or less than a number determined in advance, as the characteristic information.

3. The processing apparatus according to claim 2,
wherein the processor is configured to change the characteristic information, of which the user is to be notified, in accordance with a function to be executed by the user.

4. The processing apparatus according to claim 1,
wherein the processor is configured to notify, in a case where there are a plurality of device attributes set in the characteristic information, the user of the device attributes set in the characteristic information in accordance with an order determined in advance for each of the device attributes.

5. The processing apparatus according to claim 2,
wherein the processor is configured to notify, in a case where there are a plurality of device attributes set in the characteristic information, the user of the device attributes set in the characteristic information in accordance with an order determined in advance for each of the device attributes.

6. The processing apparatus according to claim 3,
wherein the processor is configured to notify, in a case where there are a plurality of device attributes set in the characteristic information, the user of the device attributes set in the characteristic information in accordance with an order determined in advance for each of the device attributes.

7. The processing apparatus according to claim 1,
wherein the processor is configured to display the characteristic information on a screen in correlation with an image that simulates an appearance of the host device.

8. The processing apparatus according to claim 2,
wherein the processor is configured to display the characteristic information on a screen in correlation with an image that simulates an appearance of the host device.

9. The processing apparatus according to claim 3,
wherein the processor is configured to display the characteristic information on a screen in correlation with an image that simulates an appearance of the host device.

10. The processing apparatus according to claim 4,
wherein the processor is configured to display the characteristic information on a screen in correlation with an image that simulates an appearance of the host device.

11. The processing apparatus according to claim 5,
wherein the processor is configured to display the characteristic information on a screen in correlation with an image that simulates an appearance of the host device.

12. The processing apparatus according to claim 6,
wherein the processor is configured to display the characteristic information on a screen in correlation with an image that simulates an appearance of the host device.

13. The processing apparatus according to claim 7,
wherein the processor is configured to display a position of the host device associated with the characteristic information as indicated in the image on the screen.

14. The processing apparatus according to claim 1,
wherein the processor is configured to display the characteristic information on a display device of the host device in a case where the user has performed an operation by touching the host device, and to cause a display device of a user terminal, from which the user has made a request for an operation on the host device, to display a screen that displays the characteristic information by transmitting the screen to the user terminal through an external communication line in a case where an operation from the user has been received through the external communication line.

15. The processing apparatus according to claim 1,
wherein the processor is configured to notify the user that uses the host device of device attributes that are represented by the host device information and that are not included in the characteristic information as similar information that represents device attributes also provided to the different device.

16. The processing apparatus according to claim 1,
wherein the processor is configured to notify the user of a different device with a highest degree of similarity related to the device attributes as a substitute device for the host device in a case where a trouble with the host device that renders a function designated by the user unexecutable has been detected, the substitute device for the host device being determined using a degree of similarity related to the device attributes between the host device and each of the different devices calculated from a status of overlap between the device attributes of the host device and the device attributes of each of the different devices obtained by comparing the host device information and the different device information.

17. The processing apparatus according to claim 16,
wherein the degree of similarity related to the device attributes is calculated for each function of the host device, and
the processor is configured to notify the user of a different device with a highest degree of similarity related to the device attribute correlated with the function designated by the user as the substitute device for the host device.

18. The processing apparatus according to claim 17,
wherein the processor is configured to notify the user of a different device that enables selecting a setting value that is identical to a setting value selected by the user for the function designated by the user, among a plurality of different devices, as the substitute device for the host device in a case where there are a plurality of different devices with an equal degree of similarity related to the device attribute correlated with the function designated by the user.

19. A method comprising:
referencing host device information that represents device attributes provided to a host device and different device information that represents device attributes provided to a different device; and
notifying a user that uses the host device of device attributes of the host device that are not provided to the different device as characteristic information on the host device.

20. A non-transitory computer readable medium storing a processing program causing a computer to execute a process comprising:
referencing host device information that represents device attributes provided to a host device and different device information that represents device attributes provided to a different device; and
notifying a user that uses the host device of device attributes of the host device that are not provided to the different device as characteristic information on the host device.
